(19) United States
(12) Patent Application Publication
(10) Pub. No.: US 2011/0227499 A1
(43) Pub. Date: Sep. 22, 2011

(54) LAMP MODULE

(76) Inventor: Pau-Sheng Huang, Taoyuan (TW)

(21) Appl. No.: 13/049,912

(22) Filed: Mar. 17, 2011

(30) Foreign Application Priority Data
Mar. 19, 2010 (TW) 099108100

(51) Int. Cl. H05B 41/16

(52) U.S. Cl. 315/279

(57) ABSTRACT

A lamp module for being coupled with a dimmer module includes a rectifier, a voltage lowering circuit, a driving circuit, a switching circuit, a transformer, a light emitting component, and a first stabilizing circuit. The rectifier is coupled to the dimmer module and used for outputting a first DC voltage. The voltage lowering circuit is coupled to the rectifier. The driving circuit is coupled to the voltage lowering circuit. The light emitting component is coupled to the transformer. The switching circuit is coupled to the driving circuit, the first DC voltage and the transformer, and controls the brightness of the light emitting component based on the first DC voltage. The first stabilizing circuit is arranged in parallel with the voltage lowering circuit, and directly conducts the first DC voltage to the driving circuit when the first DC voltage is smaller than a first potential.

### BACKGROUND OF THE INVENTION

1. Field of the Invention

The present invention relates to a lamp module, and more particularly, to a lamp module capable of working stably in various driving voltages.

2. Description of the Prior Art

There are different types of a conventional dimmer module, such as a DC voltage dimmer with auto-transformer, a frequency dimmer based on pulse width modulation technology, a cutoff dimmer with a triode for alternating current (TRIAC) and so on.

Taking the cutoff dimmer with a TRIAC circuit for example, most household embedded dimmer button includes a TRIAC dimmer. The cutoff dimmer with the TRIAC controls a conduction angle of an AC sinusoidal voltage. Since the TRIAC dimmer works in a cutoff wave manner, a waveform is sampled by specific phase interval. After rectification, a voltage signal is transmitted to a driving circuit of a lighting device (such as a lamp and so on), so as to control output average voltage by sample of the waveform effective phase interval for achieving the dimmer effect. The said cutoff dimmer with the TRIAC can reduce complexity of wiring for its simple configuration and for installation without disposing an additional dimmer control circuit. Furthermore, since the TRIAC dimmer hardly causes power consumption when being in rest, it can reduce power consumption.

However, by using the TRIAC to control brightness of a discharge lamp (such as a cold cathode fluorescent lamp), the driving circuit is incapable of being driven normally when the output voltage is low, so as to make the lamp sparkle. Accordingly, it will affect user's visual feeling and reduces life of the lighting device.

### SUMMARY OF THE INVENTION

Thus, the present invention provides a lamp module with a stabilizing circuit to assure a driving circuit of working without sparkling when the output voltage is low for solving above drawbacks.

According to the claimed invention, a lamp module is used for being coupled with a dimmer module, the dimmer module provides the lamp module with an AC voltage, and the lamp module includes a rectifier, a voltage lowering circuit, a driving circuit, a switching circuit, a transformer, a light emitting component, and a first stabilizing circuit. The rectifier is coupled to the dimmer module and used for outputting a first DC voltage. The voltage lowering circuit is coupled to the rectifier. The driving circuit is coupled to the voltage lowering circuit. The light emitting component is coupled to the transformer. The switching circuit is coupled to the driving circuit, the first DC voltage and the transformer, and controls the brightness of the light emitting component based on the first DC voltage. The first stabilizing circuit is arranged in parallel with the voltage lowering circuit, and directly conducts the first DC voltage to the driving circuit when the first DC voltage is smaller than a first potential.

According to the claimed invention, the first stabilizing circuit includes a first switch coupled between the dimmer module and the driving circuit, and a first comparator circuit for comparing the first DC voltage with the first potential and for controlling the first switch to directly couple the first DC voltage to the driving circuit when the first DC voltage is smaller than the first potential.

According to the claimed invention, the lamp module further includes a second stabilizing circuit for turning off the driving circuit when the first DC voltage is smaller than the first potential and a second potential.

According to the claimed invention, the second stabilizing circuit includes a second switch, and a second comparator circuit for comparing the first DC voltage with the second potential and for controlling the second switch to conduct a shut-off voltage signal to the driving circuit for turning off the driving circuit when the first DC voltage is smaller than the first potential and the second potential.

According to the claimed invention, the light emitting component includes a cold cathode fluorescent lamp.

According to the claimed invention, the lamp module further includes a voltage stabilizing circuit coupled between the voltage lowering circuit and the driving circuit.

According to the claimed invention, the dimmer module includes a triode for alternating current.

In summary, the lamp module of the present invention includes the stabilizing circuit and the stabilizing circuit is arranged in parallel with the voltage lowering circuit. When the AC voltage provided by the dimmer module is lower than the first potential, the first stabilizing circuit conducts the first DC voltage to the driving circuit to assure the driving circuit of working without sparkling.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a lamp module according to a first embodiment of the present invention.

FIG. 2 is a circuit diagram of the lamp module and a corresponding dimmer module in FIG. 1 according to the first embodiment of the present invention.

FIG. 3 is a functional block diagram of a lamp module according to a second embodiment of the present invention.

FIG. 4 is a circuit diagram of the lamp module and a corresponding dimmer module in FIG. 3 according to the first embodiment of the present invention.

FIG. 5 is a circuit diagram of a first stabilizing circuit according to an embodiment of the present invention.

FIG. 6 is a circuit diagram of a second stabilizing circuit according to an embodiment of the present invention.

### DETAILED DESCRIPTION

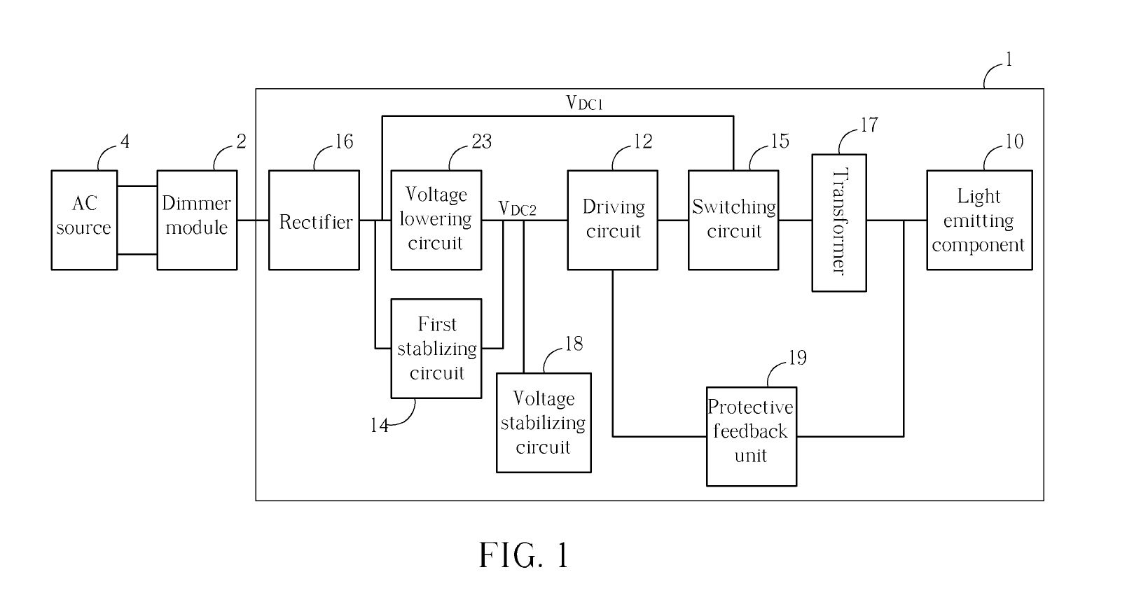

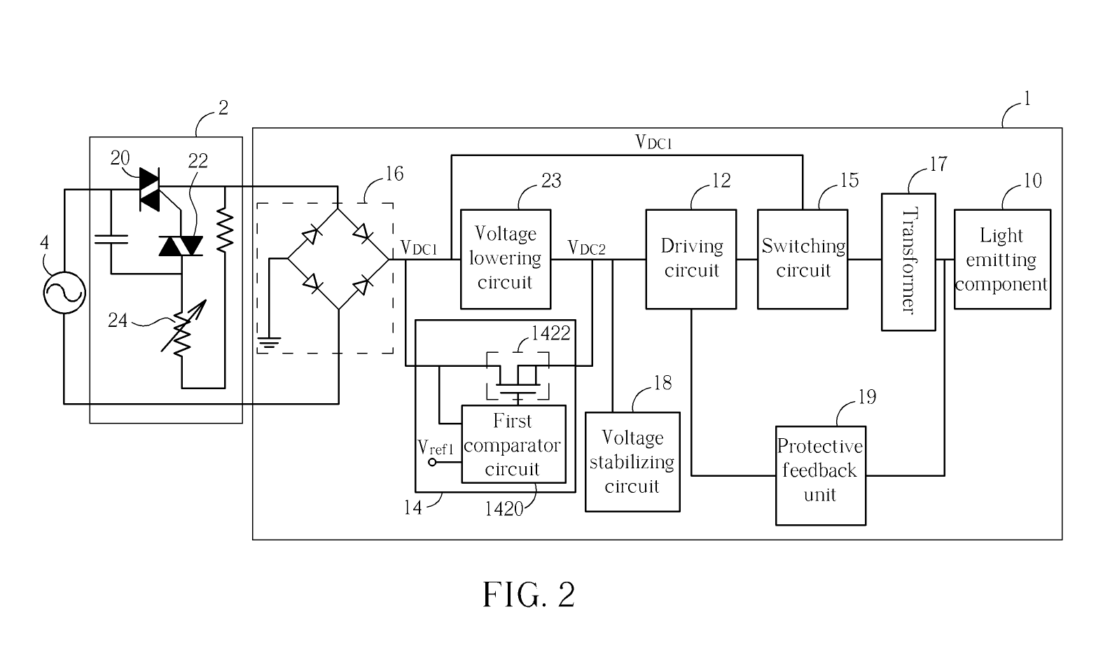

Please refer to FIG. 1 and FIG. 2. FIG. 1 is a functional block diagram of a lamp module 1 according to a first embodiment of the present invention. FIG. 2 is a circuit diagram of the lamp module 1 and a corresponding dimmer module 2 in FIG. 1 according to the first embodiment of the present invention. In this embodiment, the lamp module 1 is used for being coupled with the dimmer module 2, and the dimmer module 2 is coupled with an AC source 4. The dimmer module 2 can include a triode for alternating current 20 (TRIAC) as a dimmer. In practical application, besides the triode for alternating current 20, the dimmer module 2 further can include a diode for alternating current 22 (DIAC), a variable resistor 24 and a corresponding RC circuit. The dimmer module 2 provides the lamp module 1 with an AC voltage. The variable resistor 24 of the dimmer module 2 can be adjusted by a rotating button or other adjusting mechanism, so that a user can operate the rotating button for changing the AC voltage provided by the dimmer module 2 to the lamp module 1, so as to adjust the brightness. The structural design of the rotating button is commonly seen in the prior art, so it is not depicted herein for simplicity.

As shown in FIG. 1, the lamp module 1 includes alight emitting component 10, a driving circuit 12, a switching circuit 15, a rectifier 16, a transformer 17, a voltage stabilizing circuit 18, a voltage lowering circuit 23 and a first stabilizing circuit 14. In this embodiment, the light emitting component 10 can be, but not limited to, a discharge lamp such as a cold cathode fluorescent lamp (CCFL). The rectifier 16 is coupled to the dimmer module 2 and is used for outputting a first DC voltage V_{DC1}. The first stabilizing circuit 14 is arranged in parallel with the voltage lowering circuit 23. Since working voltage of the driving circuit 12 is far smaller than a maximum value of the first DC voltage V_{DC1}, the voltage lowering circuit 23 is adopted to lower the first DC voltage V_{DC1} to the second DC voltage V_{DC2} for avoiding the driving circuit 12 from damage. The first DC voltage V_{DC1} varies with the dimmer module 2. The driving circuit 12 is coupled to the voltage lowering circuit 23. The voltage stabilizing circuit 18 is coupled between the voltage lowering circuit 23 and the driving circuit 12 for stabling the second DC voltage V_{DC2} within a small variation, so as to assure the driving circuit 12 of working normally. The driving circuit 12 can output a driving signal to the switching circuit 15 when it works normally. The transformer 17 is coupled to the light emitting component 10 and the switching circuit 15, and performs voltage boost operation so as to drive the light emitting component 10.

The switching circuit 15 is coupled to the driving circuit 12, the first DC voltage V_{DC1} and the transformer 17. The switching circuit 15 controls brightness of the light emitting component 10 based on the first DC voltage V_{DC1} and the driving signal. When the first DC voltage V_{DC1} is high, the switching circuit 15 controls the light emitting component 10 to be with high brightness by outputting a large power. On the other hand, when the first DC voltage V_{DC1} is low, the switching circuit 15 controls the light emitting component 10 to be with low brightness by outputting a small power.

However, a threshold voltage is required for the driving circuit 12 to work normally. Otherwise, the driving circuit 12 can not output the driving signal correctly, so as to make the light emitting component 10 sparkle. For example, when the AC voltage provided by the dimmer module 2 is smaller than a specific value (e.g. 60 Volts) , the second DC voltage V_{DC2} from the voltage lowering circuit 23 will be lower than working voltage which the driving circuit 12 needs. At the same time, the first stabilizing circuit 14 can detect that the first DC voltage V_{DC1} is smaller than a first potential Vref1, and directly conducts the first DC voltage V_{DC1} to the driving circuit 12. In such a manner, the first stabilizing circuit 14 makes the first DC voltage V_{DC1} be directly coupled to the driving circuit 12 without passing the voltage lowering circuit 23, so as to drive the driving circuit 12 to work normally.

As shown in FIG. 2, the first stabilizing circuit 14 can include a first comparator circuit 1420 and a first switch 1422. The first switch 1422 is coupled between the dimmer module 2 and the driving circuit 12. The first comparator circuit 1420 is used for comparing the first DC voltage V_{DC1} with the first potential Vref1, as shown in FIG. 2. When the first DC voltage V_{DC1} is smaller than the first potential Vref1, the first comparator circuit 1420 drives the first switch 1422 to directly conduct the first DC voltage V_{DC1} from the dimmer module 2 to the driving circuit 12. In practical application, the first potential Vref1 can be generated by a resistive divider circuit based on the first DC voltage. In this embodiment, the first switch 1422 is, but not limited to, a transistor switch component, as show in FIG. 2.

In addition, as shown in FIG. 1 and FIG. 2, the lamp module 1 can further include a protective feedback unit 19 coupled to a high voltage end of the transformer 17. When the protective feedback unit 19 detects that the light emitting component 10 works abnormally (e.g. open circuit, short circuit and so on), the protective feedback unit 19 can generate a feedback signal to the driving circuit 12, so as to turn off the driving circuit 12. In this embodiment, the driving circuit 12 can adopt a IR2153 integrated circuit generated by IR corporation, the voltage stabilizing circuit 14 can adopt Zener Diode, the switching circuit 15 can adopt a half bridge switching circuit, and the light emitting component 10 can adopt CCFL.

In summary, the lamp module 1 in the first embodiment of the present invention has the first stabilizing circuit 14 arranged in parallel with the voltage stabilizing circuit 18. When the AC voltage provided by the dimmer module 2 is lower than the first potential Vref1, the first stabilizing circuit 14 conducts the first DC voltage V_{DC1} to the driving circuit 12 to assure the driving circuit 12 of working without sparkling.

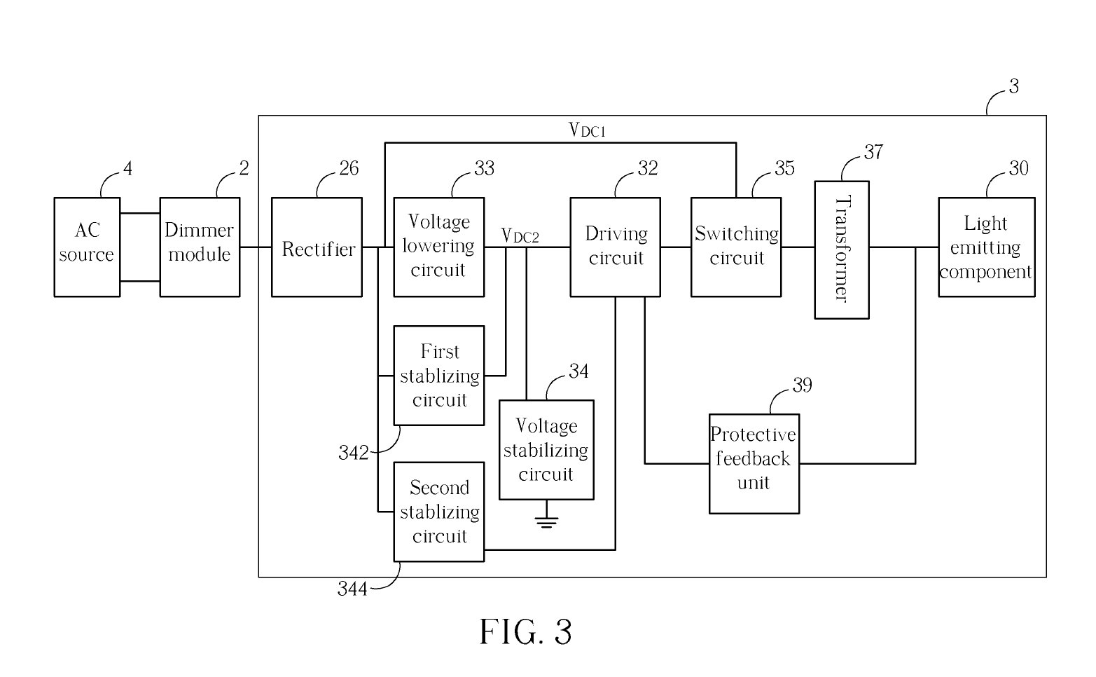

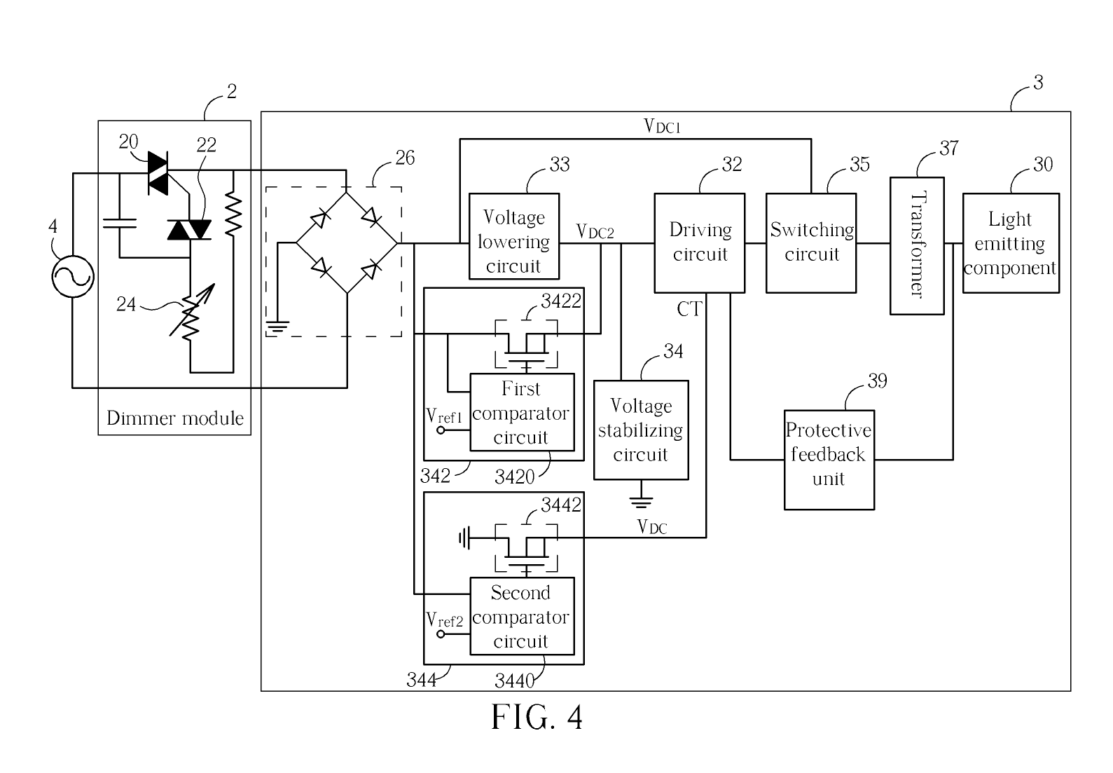

Please refer to FIG. 3 and FIG. 4. FIG. 3 is a functional block diagram of a lamp module 3 according to a second embodiment of the present invention. FIG. 4 is a circuit diagram of the lamp module 3 and a corresponding dimmer module 2 in FIG. 3 according to the second embodiment of the present invention. As shown in FIG. 3, the lamp module 3 includes a light emitting component 30, a driving circuit 32, a switching circuit 35, a rectifier 26, a transformer 37, a voltage stabilizing circuit 34, a voltage lowering circuit 33, a first stabilizing circuit 342 and a protective feedback unit 39. In the second embodiment, detailed working principle of the lamp module 3 and the above-mentioned inner components thereof are similar to those in the first embodiment, so it is not depicted herein for simplicity.

It should be noticed that the main difference between the lamp module 3 and the said lamp module 1 is that the lamp module 3 further includes a second stabilizing circuit 344. In the second embodiment, when the AC voltage provided by the dimmer module 2 is smaller than the first potential (e.g. 60 Volts as Vref1 shown in FIG. 4) and further smaller than a second potential (e.g. 15 Volts as Vref2 shown in FIG. 4), the second stabilizing circuit 344 turns off a driving circuit 32 for shutting off a light emitting component 30, so as to avoid the light emitting component 30 from sparkling.

In practical application, the second stabilizing circuit 344 can include a second comparator circuit 3440 and a second switch 3442 (as shown in FIG. 4). The second comparator circuit 3440 is used for comparing the first DC voltage V_{DC1} with the second potential Verf2. When the first DC voltage V_{DC1} is smaller than the first potential Vref1 and the second potential Verf2, the second comparator circuit 3440 controls the second switch 3442 to conduct a shut-off voltage signal V_{DC} (as shown in FIG. 4) to the driving circuit 32 for turning off the driving circuit 32.

In such a manner, the lamp module 3 features a multi-step source control unit. In this embodiment, the lamp module 3 has the following three-step activation mode:

1. When the first DC voltage V_{DC1} is larger than the first potential Vref1, the lamp module 3 utilizes a voltage lowering circuit 33 to lower the first DC voltage V_{DC1} down to the second DC voltage V_{DC2}, and then utilizes the second DC voltage V_{DC2} as well as the voltage stabilizing circuit 34 to make the driving circuit 32 work normally.

2. When the first DC voltage V_{DC1} is between the first potential Vref1 and the second potential Vref2, the lamp module 3 utilizes the first stabilizing circuit 342 to directly conduct the first DC voltage V_{DC1} to the driving circuit 32, cooperating with the voltage stabilizing circuit 34 so as to make the driving circuit 32 work normally.

3. When the first DC voltage V_{DC1} is smaller than the second potential Vref2, the lamp module 3 utilizes the second stabilizing circuit 344 to turn off the driving circuit 32.

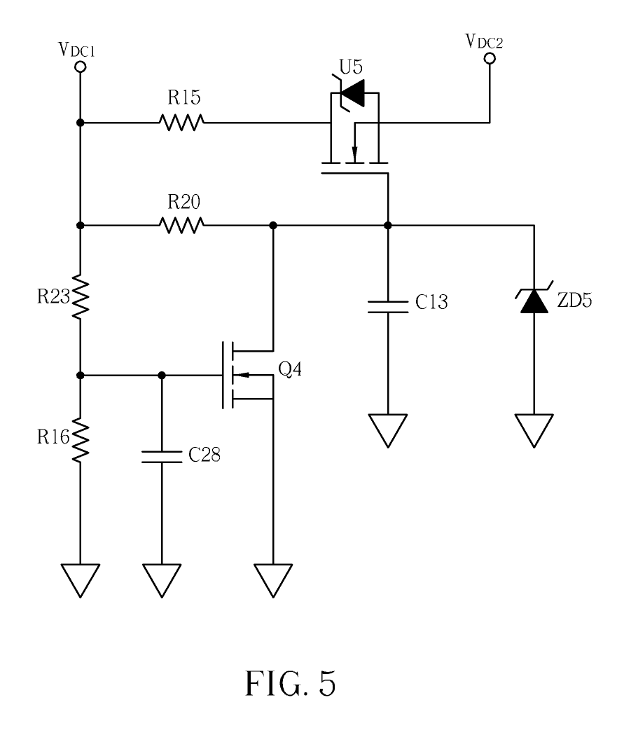

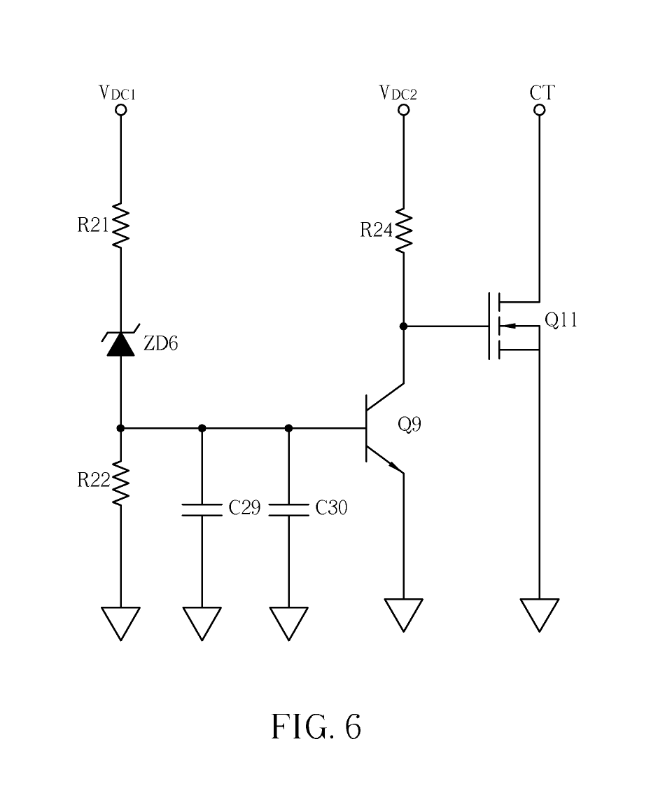

As for the detailed circuit diagram of the above-mentioned first stabilizing circuit 342 and the second stabilizing circuit 344, please refer to FIG. 5 and FIG. 6. It should be noticed that circuit designs of the first stabilizing circuit 342 and the second stabilizing circuit 344 are not limited to those mentioned in FIG. 5 and FIG. 6. In other words, circuit designs capable of reaching the goal mentioned above are within the scope of the present invention.

Compared with the prior art, the lamp module of the present invention includes the stabilizing circuit arranged in parallel with the voltage lowering circuit. When the first DC voltage is lower than the first potential, the stabilizing circuit can conduct the first DC voltage to the driving circuit. As a result, the lamp module of the present invention can assure the driving circuit of working without sparkling.

Those skilled in the art will readily observe that numerous modifications and alterations of the device and method may be made while retaining the teachings of the invention.

What is claimed is:

1. A lamp module for being coupled with a dimmer module, the dimmer module providing the lamp module with an AC voltage, the lamp module comprising:
a rectifier coupled to the dimmer module and for outputting a first DC voltage;
a voltage lowering circuit coupled to the rectifier;
a driving circuit coupled to the voltage lowering circuit;
a transformer;
a light emitting component coupled to the transformer;
a switching circuit coupled to the driving circuit, the first DC voltage and the transformer, the switching circuit controlling brightness of the light emitting component based on the first DC voltage; and
a first stabilizing circuit arranged in parallel with the voltage lowering circuit, the first stabilizing circuit directly conducting the first DC voltage to the driving circuit when the first DC voltage is smaller than a first potential.

2. The lamp module of claim 1, wherein the first stabilizing circuit comprises:
a first switch coupled between the dimmer module and the driving circuit; and
a first comparator circuit for comparing the first DC voltage with the first potential and for controlling the first switch to directly couple the first DC voltage to the driving circuit when the first DC voltage is smaller than the first potential.

3. The lamp module of claim 1, further comprising a second stabilizing circuit for turning off the driving circuit when the first DC voltage is smaller than the first potential and a second potential.

4. The lamp module of claim 3, wherein the second stabilizing circuit comprises:
a second switch; and
a second comparator circuit for comparing the first DC voltage with the second potential and for controlling the second switch to conduct a shut-off voltage signal to the driving circuit for turning off the driving circuit when the first DC voltage is smaller than the first potential and the second potential.

5. The lamp module of claim 1, wherein the light emitting component comprises a cold cathode fluorescent lamp.

6. The lamp module of claim 1, further comprising a voltage stabilizing circuit coupled between the voltage lowering circuit and the driving circuit.

7. The lamp module of claim 1, wherein the dimmer module comprises a triode for alternating current.
